(19) United States
(12) Patent Application Publication
(10) Pub. No.: US 2024/0246157 A1
(43) Pub. Date: Jul. 25, 2024

(54) CUTTING HEAD LUBRICATION MECHANISM

(71) Applicant: Seco Tools Tooling Systems, Bouxwiller (FR)

(72) Inventors: Claude JAEGER, Monswiller (FR); Sebastien HOPFNER, Thal Marmoutier (FR)

(21) Appl. No.: 16/769,958

(22) PCT Filed: Nov. 30, 2018
(86) PCT No.: PCT/EP2018/083222

§ 371 Date: Jul. 7, 2023

(30) Foreign Application Priority Data
Dec. 5, 2017 (FR) 1761658

(51) Int. Cl. B23B 51/06; B23B 27/10

(52) U.S. Cl. CPC B23B 51/068; B23B 27/10; B23B 2231/24; B23B 2250/12

(57) ABSTRACT

The object of this invention concerns a boring head (1) including a cutting insert (2), characterised in that the body of the boring head (1) includes, in its thickness, at least one device to allow for the displacement of a liquid, said device including at least two orifices (3) in the surface of the boring head (1) located in the vicinity of the insert (2).

This invention concerns the field of boring head lubrication mechanisms and more specifically the field of boring head lubrication mechanisms including a removable cutting insert.

It is current standard practice to lubricate or cool a boring head by means of a liquid projected onto the cutting surface of the boring head.

A standard mechanical arrangement to achieve such lubrication or cooling consists of a line inserted into the body of the boring head whose orifice opens in the vicinity of the cutting surface. The line created within the body of the boring head thereby constitutes a device supplying liquid lubricant or coolant to be projected onto the cutting surface.

However, it may be that the position of the orifice of the supply line is affected by the specific architecture of the section of the boring head that holds the cutting surface and that the quality of the projection onto the cutting surface is impacted by this.

Likewise, the liquid lubricant or coolant is projected onto the cutting surface at a particular point on the cutting surface. However, when the cutting surface of the insert extends to a greater length than the impact point of the liquid on the insert, the cooling of the entire cutting surface is then achieved through secondary projections or a liquid flow. The quality of cooling or lubrication is then impacted by this.

Similarly, when the insert is mounted removably, namely so that it can be displaced or adjusted positionally on the boring head, the cutting surface or cutting point is modified as a result. Thus, as the orifice of the lubricant or coolant supply line is fixed, the impact point of the liquid projected onto the insert is changed so that the orifice no longer allows the liquid to be projected onto a point of the cutting surface allowing for optimal cooling or lubrication of the boring insert.

The purpose of this invention is to offset this disadvantage by supplying a mechanism that allows the lubrication or cooling of the cutting surface of a boring head to be optimised, while maintaining optimal lubrication whatever the position of the cutting surface when this is movable on the boring head.

The object of the invention is therefore a boring head including a cutting insert characterised in that the body of the boring head includes at least one device to allow for the displacement of a liquid, the device including at least two orifices on the surface of the boring head that are placed in the vicinity of the insert.

The invention will be better understood thanks to the description below, which concerns a preferred embodiment, provided as a non-exclusive example and explained with reference to the schematic drawings attached, in which:

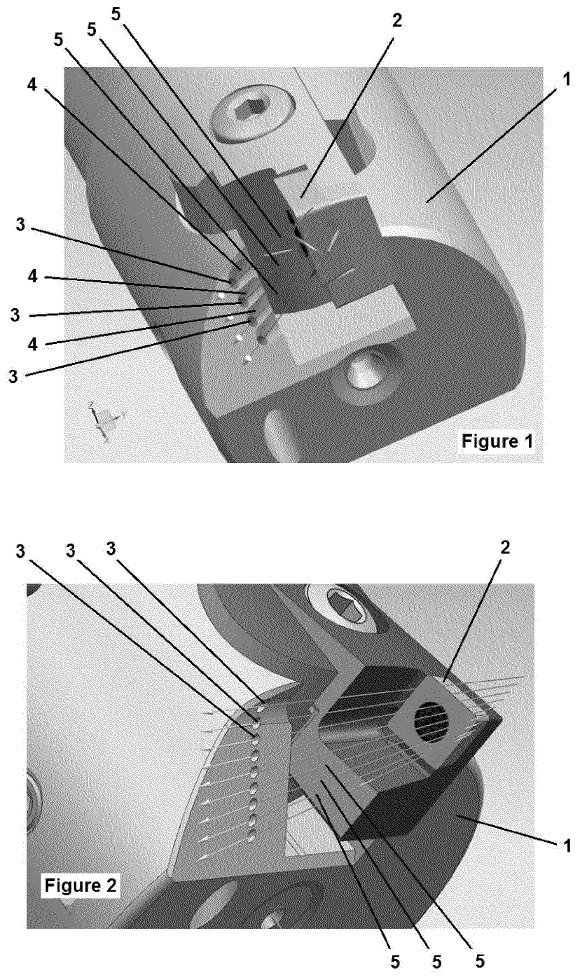

FIG. 1 is a schematic depiction of a first example of a boring head constructed according to the invention;

FIG. 2 is a schematic depiction of a second example of a boring head constructed according to the invention;

The object of the invention is therefore a boring head 1 including a cutting insert 2, characterised in that the body of the boring head 1 includes, in its thickness, at least one device to allow for the displacement of a liquid, the device including at least two orifices 3 on the surface of the boring head located in the vicinity of the insert 2.

Additionally, the device includes at least three orifices 3.

A boring head under the invention that includes a plurality of orifices 3 on its surface in the vicinity of the insert 2 constituting the cutting surface allows for a multiplication, firstly, of liquid projection angles and, secondly, of liquid projection points on the cutting surface. This multiplication of liquid projections on the insert 2 leads to the optimal distribution of the liquid coolant or lubricant on the cutting surface. The multiplication of liquid projection impact points on the insert 2 allows the liquid coolant to be distributed across a greater length or area compared to the liquid projection effected from a single orifice 3.

According to one construction feature of the invention, the boring head 1 is characterised in that at least two orifices 3 are positioned at different heights on the edge of the cutting edge of the insert 2. Such a construction thereby allows for the optimal distribution of the liquid coolant or lubricant along the edge of the cutting insert 2.

According to another complementary construction feature of the invention, the boring head 1 is characterised in that the device for the displacement of the liquid includes at least one line along which at least two orifices 3 are positioned. According to this construction feature, the orifices 3 are supplied through the same section of a single line. It should be noted that, although this construction is easy to put into practice, the pressure of the liquid leaving the orifice 3 decreases between the orifice 3 that is the furthest upstream from the liquid flow in the line and the orifice 3 that is the furthest downstream. However, when the at least two orifices 3 are sufficiently close together, this variation in pressure is liable to be negligible as regards the quality of the liquid projection onto the cutting insert 2.

According to another complementary construction feature, the boring head 1 according to the invention is characterised in that the device for the displacement of a liquid includes one main line that is subdivided into at least two secondary lines, each secondary line including at least one corresponding orifice 3, such that these corresponding orifices 3 connect to at least two orifices 3. According to this construction feature, the supply to each of the orifices 3 is made by a corresponding line. It should be noted that, although the architecture of such a construction is more complex to put into practice than that with a single line, the branching of several secondary lines from a main line allows one to obtain a liquid projection from the orifices 3 that is made with a pressure essentially identical between the different orifices 3. Thus, the liquid projection from the orifices 3 is standardised across the cutting insert 2 as a whole.

According to another complementary construction feature, the boring head 1 according to the invention is characterised in that, with the cutting insert 2 being mounted movably on the boring head 1, the at least two orifices 3 are arranged along an axis approximately parallel to the displacement axis of the cutting insert 2. According to this construction feature, the projection of liquid lubricant or coolant is effected along the alignment displacement path of the cutting insert 2. Thus, whatever the alignment position of the cutting insert 2, the liquid lubricant or coolant is projected optimally across the operational cutting surface.

According to another complementary construction feature, the boring head 1 according to the invention is characterised in that, for at least one orifice 3, the surface of the boring head 1 includes a slot 4 oriented from the orifice 3 towards at least one position of the cutting insert 2. According to this construction feature, the slot 4 creates a groove formed in the surface of the boring head 1. Preferentially, this slot 4 is arranged along an axis 5 corresponding approximately to an axis 5 perpendicular to the plane of the orifice 3. This slot 4 allows one to optimise the guidance of the liquid outflow projected from the orifice 3 against the cutting insert 2.

According to one embodiment of this construction feature, the boring head 1 according to the invention is characterised in that, with the boring head 1 including at least two slots 4 oriented from at least two corresponding orifices 3, the at least two slots 4 are oriented along axes 5 approximately parallel to one another. This embodiment thereby allows one to optimise the orientation and guidance of the liquid flow projected at multiple points of the assembly of a length corresponding to at least part of the cutting insert 2.

According to an alternative embodiment of this construction feature, or a partially complementary embodiment of the embodiment described previously, the boring head 1 according to the invention is characterised in that, with the boring head 1 including at least two slots 4 oriented from at least two corresponding orifices 3, the at least two slots 4 are oriented along axes 5 that form an intersection in the vicinity of one position on the cutting insert 2. According to this embodiment, the slots 4 allow all or part of the liquid flow to be concentrated at a particular point on the cutting insert 2. This concentration of the projection from the different orifices 3 also allows for a liquid projection onto the cutting insert 2 from different angles and therefore the optimisation of the cooling and/or lubrication of the cutting insert 2 compared to a projection from a single orifice.

According to another complementary construction feature, the boring head 1 according to the invention is characterised in that the device to allow the displacement of a liquid is adapted to the flow of a liquid lubricant.

According to another complementary construction feature, the boring head 1 according to the invention is characterised in that the device to allow the displacement of a liquid is adapted to the flow of a liquid coolant.

Clearly, the invention is not limited to the embodiments described and depicted in the drawings appended. Modifications remain possible, particularly as regards the constitution of the various items or through the substitution of equivalent techniques, without thereby departing from the scope of protection of the invention.

1. A boring head comprising:
a cutting insert having a displacement axis; and
a body having a thickness, the body of the boring head including, in its thickness, at least one device arranged for displacement of a liquid, said device including at least two orifices in a surface of the boring head located in a vicinity of the insert, wherein the cutting insert is mounted movably on the boring head, the at least two orifices being arranged along an axis approximately parallel to the displacement axis of the cutting insert.

2. The boring head according to claim 1, wherein the at least two orifices are positioned at different heights from an edge of the cutting insert.

3. The boring head according to claim 1, wherein the at least one device for the displacement of the liquid includes at least one line along which the at least two orifices are positioned.

4. The boring head according to claim 1, wherein the at least one device for the displacement of the liquid includes a main line that is subdivided into at least two secondary lines, each secondary line including at least one corresponding orifice, such that the at least one corresponding orifice communicates with at least two orifices.

5. The boring head according to claim 1, wherein, for at least one orifice, the surface of the boring head includes a slot oriented from the at least one orifice towards at least one position of the cutting insert.

6. The boring head according to claim 5, further comprising at least two slots oriented from at least two corresponding orifices, the at least two slots being oriented along axes approximately parallel to one another.

7. The boring head according to claim 5, further comprising at least two slots oriented from at least two corresponding orifices, the at least two slots being oriented along axes that create an intersection in the vicinity of one position of the cutting insert.

8. The boring head according to claim 1, wherein the device for the displacement of the liquid is arranged for the flow of a liquid lubricant.

9. The boring head according to claim 1, wherein the device for the displacement of the liquid is arranged for the flow of a liquid coolant.
